(19) United States
(12) Patent Application Publication
(10) Pub. No.: US 2010/0079267 A1
(43) Pub. Date: Apr. 1, 2010

(54) Automobile Anti-Collision Early-Warning Device

(76) Inventor: Tsun-Huang LIN, Yonghe City (TW)

Correspondence Address: TROXELL LAW OFFICE, PLLC, P.O. Box 1370, Annandale, VA, 22003, US

(21) Appl. No.: 12/240,632

(22) Filed: Sep. 29, 2008

(51) Int. Cl. B60Q 1/00

(52) U.S. Cl. 340/435

(57) ABSTRACT

The present invention relates to an automobile anti-collision early-warning device, which is structured from a main unit used for processing images and a plurality of camera devices. The main unit is internally provided with a holding space, within which a system board is located. The system board is configured with an image analysis unit, an early-warning message unit, a speed signal unit, a video recording unit and a sound signal unit. Moreover, a plurality of electrical members respectively extend from the system board and separately connect to the plurality of camera devices. Accordingly, when the driver activates the anti-collision early-warning device, then the anti-collision early-warning device begins to transmit images to the main unit through the camera devices, whereupon safety distances between vehicles are simultaneously calculated, thereby achieving monitoring of safe distances between front and rear vehicles at all times when driving.

### BACKGROUND OF THE INVENTION

(a) Field of the Invention

The present invention provides an automobile anti-collision early-warning device, and more particularly provides an automobile anti-collision early-warning system which uses electronic image comparison to calculate the distances to front and rear vehicles to achieve monitoring of safe distances between front and rear vehicles at all times.

(b) Description of the Prior Art

The automobile has become an essential means of transport in modern society, and there are a great many types of vehicles, the most commonly purchased vehicles by consumers being sports cars, passenger cars, oversize vehicles, and so on. The majority of old-style vehicles lack the so-called power steering wheel, thus, the driver must exert substantial effort when turning the steering wheel, and which is even more exhausting for the professional driver. Hence, understanding and sympathizing with the hardship of drivers, vehicle factories have more recently added an oil pressure device to the steering wheel to enable the steering wheel to be more easily turned, thus enabling the driver to more easily rotate the steering wheel when turning a corner.

Progress in the automobile industry is obvious to all, and nearly all modern vehicles are equipped with technical equipment, including substantial utilization of electronic products, such as CD (compact disc) player devices, liquid crystal screens, and so on. Automobiles are not just a means of transport for carrying passengers, but have already become a comprehensive unit integrating recreation and technology. Moreover, safety equipment are becoming more accommodating to the motor habits of people, with vehicles now being installed with numerous safety airbags to increase the safety of persons inside the vehicle. Furthermore, along with developmental takeoff of car beautification, more and more people cherish their cars, and take more loving care to keep the car body in good repair. Hence, car factories have started to research and develop integrated high-tech radar devices, which are used in distance-measuring radar systems and front vehicle radar systems.

Generally speaking, automobile anti-collision systems are largely structured from several distance measuring devices and several image sensing systems, which enable measuring safe distances between vehicles when moving, and as soon as an abnormal condition is detected, then the anti-collision system self-activates the brake system or warning equipment, thereby substantially reducing accident occurrence.

Millimeter wave radar anti-collision systems and optical laser radar anti-collision systems are the most widespread examples of front radar systems used as automobile anti-collision systems, wherein the frequency of millimeter wave anti-collision systems is 77 GHz, while laser radar anti-collision primarily are 900 nm infrared short pulse modulation systems; advantages of which include the ability to measure object distances, as well as having the ability to measure parameters, including object relative speed, directional angle, and so on.

Referring to FIG. 1, which shows an implementation schematic view of an anti-collision system of the prior art, and it can be clearly seen from the drawings that when a vehicle 1 is moving, then a distance measurement sensor system 11 Installed on the vehicle 1 begins to transmit signal waves. When the distance measurement sensor system 11 senses that a rear vehicle 12 is approaching, then a signal message is transmitted to a sound device 13 within the vehicle 1 by radar, whereupon the sound device 13 emits a warning sound, thereby notifying the driver of the vehicle 1 of the approaching rear vehicle 12 and possible collision, thus avoiding the need for the driver to look back to see whether or not the rear vehicle 12 is drawing near the rear of the vehicle 1; instead the driver needs only listen for whether or not the sound device 13 is emitting a sound, thus providing for a relaxed and convenient driving experience.

However, the following problems and shortcomings are still in need of improvement when using the aforementioned distance measurement sensor system 11 of the prior art:

1. Although the distance measurement sensor system 11 provides the driver with relaxed and safe driving, however, the distance measurement sensor system 11 is oversized, installation is difficult and the system is expensive.

2. If a special GPS (Global Positioning System) satellite positioning anti-collision system is used, then the vehicle 1 must also be similarly provided with a GPS satellite positioning anti-collision system, however, the influence and interference of terrain makes the system unserviceable. Hence, the system is extremely inconvenient and impractical.

3. Other more advanced LDW (Lane Departure Warning) anti-collision systems using lane departure images can only be used on roads having correct traffic lane separation lines, and on general roads exist in name only.

Hence, it is the strong desire of the inventor and manufacturers engaged in related art and purpose of the present invention to resolve and surmount existent technical difficulties to resolve the problems and shortcomings of the aforementioned prior art.

### SUMMARY OF THE INVENTION

Hence, in light of the shortcomings of the aforementioned prior art, the inventor of the present invention, having collected related data, and through evaluation and consideration from many aspects, as well as having accumulated years of experience in related arts, through continuous testing and improvements has designed a new automobile anti-collision early-warning device which uses analysis from an electronic image processor to rapidly calculate the distances between the automobile installed with the automobile anti-collision early-warning device and front and rear vehicles to achieve monitoring of distances between the automobile installed with the automobile anti-collision early-warning device and front and rear vehicles at all times.

A primary objective of the present invention lies in: a system board located within an image processing main unit, the system board being configured with an image analysis unit, an early-warning message unit, a speed signal unit, a video recording unit, a program modification unit, an emergency signal unit and a sound signal unit. Moreover, a plurality of electrical members extend from the system board, and the electrical members are connected to various camera devices, thereby enabling the image processing main to operate in synchronization with the camera devices. The camera devices transmit images to the image analysis unit, whereupon the image analysis unit immediately analyzes the image signals. If the distance between vehicles is excessively close, then the early-warning message unit immediately transmits a message to the sound signal unit, and a warning sound is emitted. According to the art described above, the present invention provides a breakthrough in solving the existing problems of oversize, difficult installation and expensive price of distance-measuring radar systems of the prior art, and achieves using image signals to calculate the distance between vehicles, thereby enabling the driver to be clearly aware of safe distances to other vehicles when driving his vehicle, and realizing the practical advancement of warning functionality.

Furthermore, the present invention uses the following course of action and electronic imaging technology to effect automobile distance measurement and provide anti-collision functionality:

(1) Utilizes existing objects or objects newly proposed in accordance with the law on an automobile.

(2) The object has standard dimensions and characteristics (such as the license plate having fixed dimensions and characteristics).

(3) Utilizes size of the object in an image to calculate vehicle distance;

(4) Utilizes vehicle speed and distance to obtain data determining whether or not the vehicle is at a safe distance.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an implementation schematic view of an anti-collision system of the prior art.

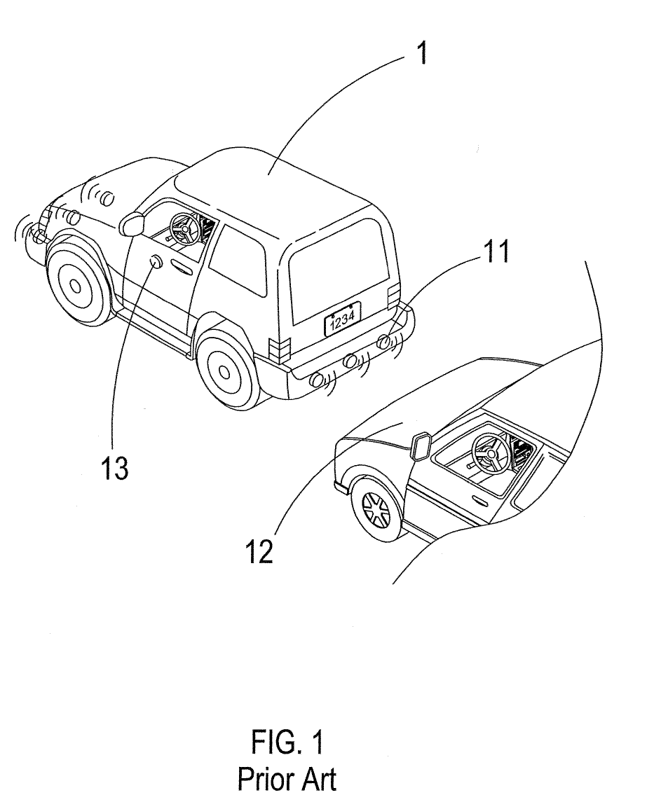

FIG. 2 shows an elevational view of a preferred embodiment of the present invention.

FIG. 3 shows a partial exploded view of a preferred embodiment of the present invention.

FIG. 4 shows an operational schematic view of a preferred embodiment of the present invention.

FIG. 5 shows a block diagram of a preferred embodiment of the present invention.

FIG. 6 shows a flow chart of a preferred embodiment of the present invention.

FIG. 7 shows an implementation schematic view of a preferred embodiment of the present invention.

### DETAILED DESCRIPTION OF THE PREFERRED EMBODIMENTS

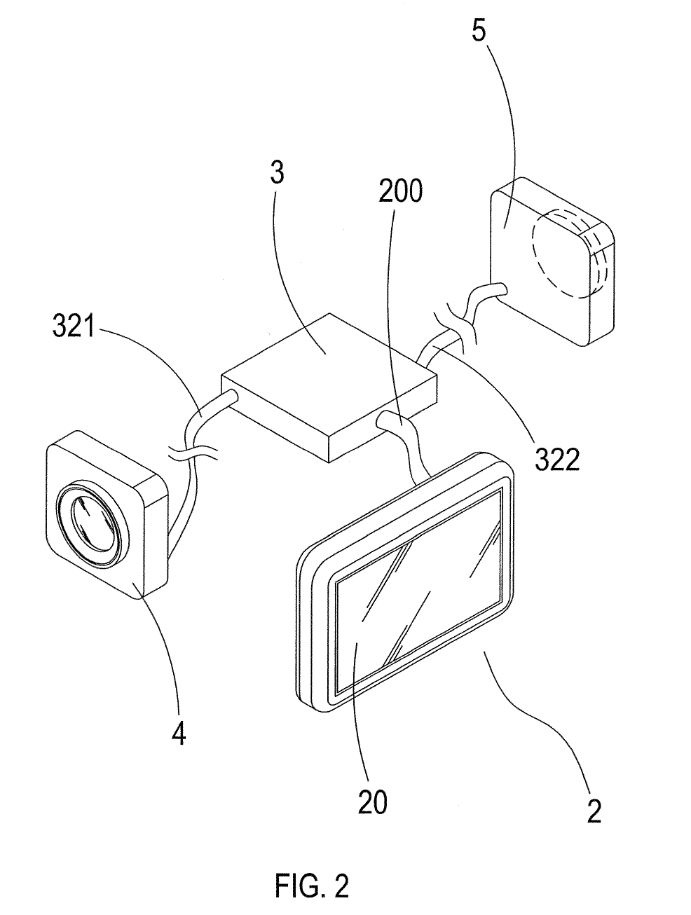

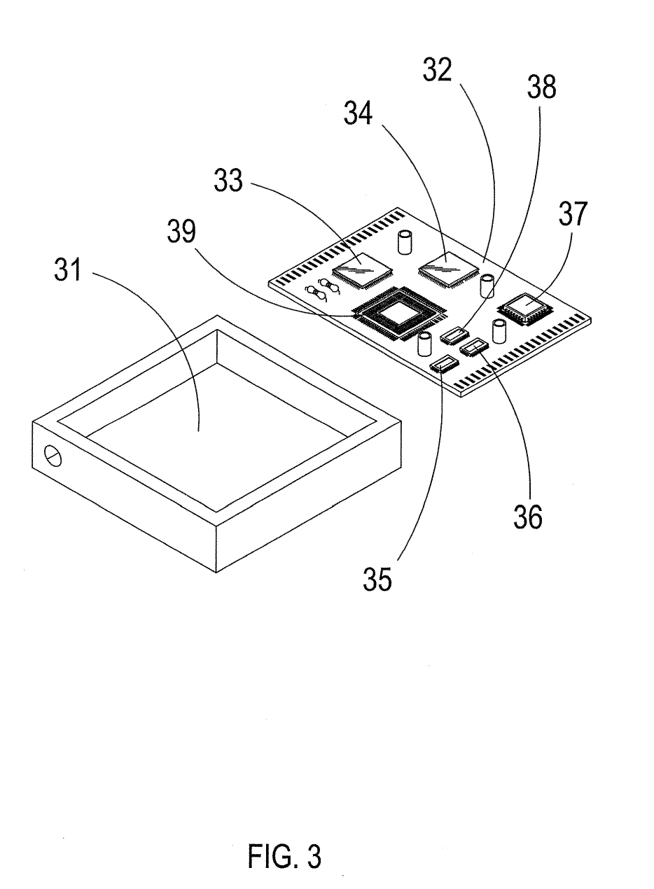

Referring to FIG. 2 and FIG. 3, which show an elevational view and a partial exploded view respectively of a preferred embodiment of the present invention, and it can be clearly seen from the drawings that an anti-collision early-warning device 2 of the present invention is structured to comprise an image processing main unit 3, a front camera device 4, a rear camera device 5 and a display device 20. The image processing main unit 3 is internally provided with a holding space 31, and a system board 32 is located interior of the holding space 31. The system board 32 is configured with an image analysis unit 33, an early-warning message unit 34, a speed signal unit 35, a video recording unit 36, a program modification unit 37, an emergency signal unit 38 and a sound signal unit 39. Moreover, a first electrical member 321 extends from the system board 32, and the first electrical member 321 is connected to the front camera device 4. Furthermore, a second electrical member 322 additionally extends from the system board 32, and the second electrical member 322 is connected to the rear camera device 5. In addition, the display device 20 is connected to the image processing main unit 3 using a third electrical member 200. Accordingly, a driver is able to view the status of front and rear moving vehicles through the display device 20.

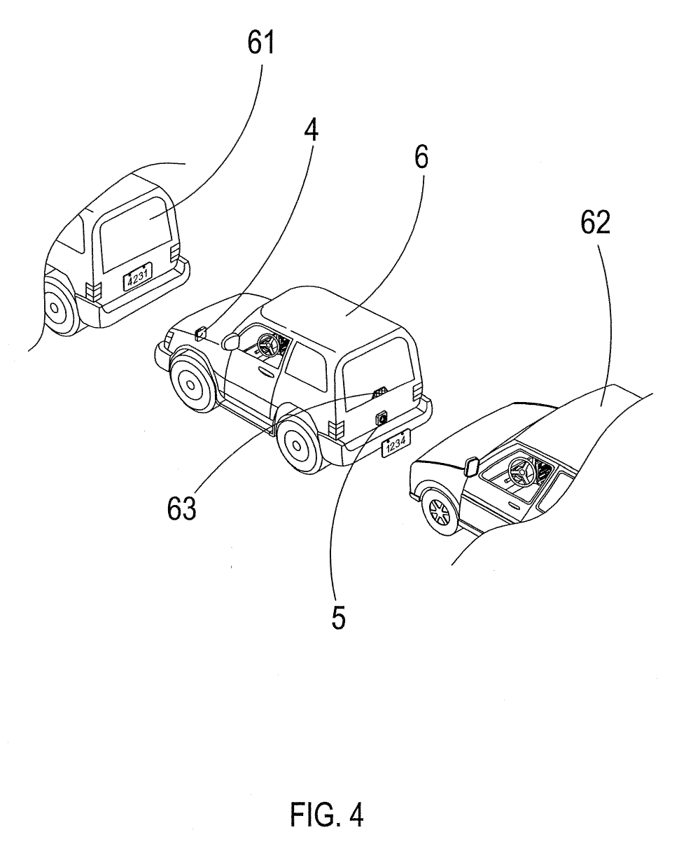

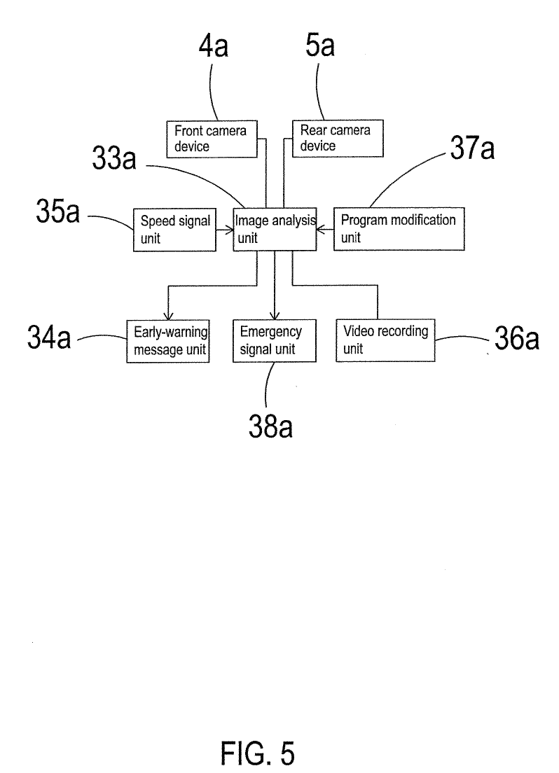

According to the aforementioned structure and constructional design, circumstances during operational use of the present invention are described hereinafter. Referring together to FIG. 4 and FIG. 5, which show an operational schematic view and a block diagram respectively of a preferred embodiment of the present invention, and it can be clearly seen from the drawings that the front camera device 4 is located at the front of a car body 6, and the rear camera device 5 is located at the rear of the car body 6. When a front vehicle 61 or a rear vehicle 62 enters the line of sight of the car body 6, then a front camera device 4a or a rear camera device 5a transmits images to an image analysis unit 33a, and at the same time a speed signal unit 35a operates in synchronization therewith. If a program requires updating, then a implements modification update. Furthermore, when the speed signal unit 35a calculates a value indicating that the distance of the front vehicle 61 or the rear vehicle 62 is excessively close to the car body 6, then the image analysis unit 33a transmits a message to an early-warning message unit 34a, and after receiving the message, the early-warning message unit 34a emits a warning sound. As the distance between the vehicles becomes shorter, then an emergency signal unit 38a is immediately actuated, and causes the warning sound to become louder and high-pitched, thereby enabling the driver to be clearly aware of the current distance between the vehicles. Moreover, a video recording unit 36a is able to record the current driving status of the vehicles. In addition, when the rear vehicle 62 approaches too close to the car body 6, then a third brake light 63 is turned on.

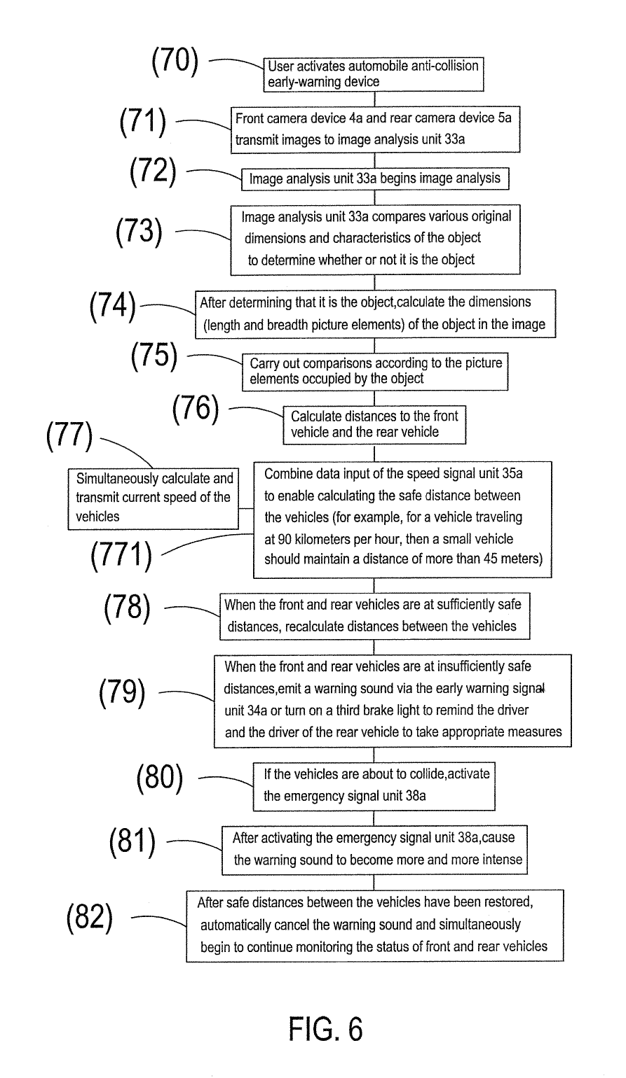

Referring together to FIG. 5 and FIG. 6, which show the block diagram and a flow chart respectively of a preferred embodiment of the present invention, and it can be clearly seen from the drawings that the following procedure is implemented when using the present invention:

(70) User activates the automobile anti-collision early-warning device;

(71) The front camera device 4a and the rear camera device 5a transmit images to the image analysis unit 33a;

(72) The image analysis unit 33a begins image analysis;

(73) The image analysis unit 33a compares various original dimensions and characteristics of the object to determine whether or not it is the object;

(74) After determining that it is the object, calculate the dimensions (length and breadth picture elements) of the object in the image;

(75) Carry out comparisons according to the picture elements occupied by the object;

(76) Calculate distances to the front vehicle and the rear vehicle;

(77) Simultaneously calculate and transmit current speed of the vehicles;

(771) Combine data input of the speed signal unit 35a to enable calculating the safe distance between the vehicles (for example, for a vehicle traveling at 90 kilometers per hour, then a small vehicle should maintain a distance of more than 45 meters);

(78) When the front and rear vehicles are at sufficiently safe distances, recalculate distances between the vehicles;

(79) When the front and rear vehicles are at insufficiently safe distances, emit a warning sound via the early warning signal unit 34a or turn on a third brake light to remind the driver and the driver of the rear vehicle to take appropriate measures;

(80) If the vehicles are about to collide, activate the emergency signal unit 38a;

(81) After activating the emergency signal unit 38a, cause the warning sound to become more and more intense;

(82) After safe distances between the vehicles have been restored, automatically cancel the warning sound and simultaneously begin to continue monitoring the status of front and rear vehicles.

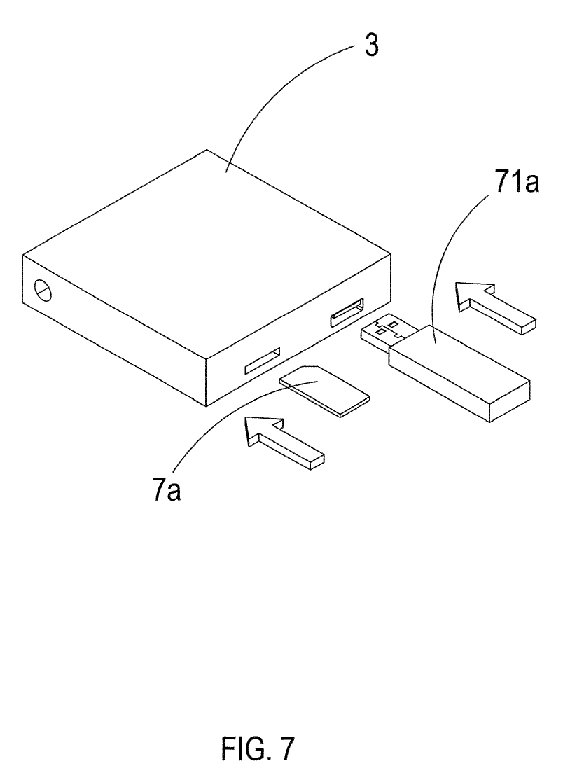

Referring to FIG. 7, which shows an implementation schematic view of a preferred embodiment of the present invention, and it can be clearly seen from the drawings that a device enabling long-term storage of image signals, such as a memory card 7a or a mobile drive 71a, and the like, can be further inserted into the image processing main unit 3.

Hence, referring to all the drawings, compared to the prior art, the following advantages exist when using the present invention:

1. The anti-collision early-warning device 2 can be independently installed, and does not need to be combined with other equipment in order to function.

2. Terrain features do not affect accurate monitoring of vehicles.

3. Can be used with other systems to functionally share the front camera device 4 and the rear camera device 5, and installation cost is inexpensive.

4. The anti-collision early-warning device 2 is able to monitor great distances, and response time is fast.

In conclusion, the automobile anti-collision early-warning device of the present invention is clearly able to achieve effectiveness and objectives when in use, and is indeed a practical and exceptional invention that complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An automobile anti-collision early-warning device, comprising a main unit and a plurality of camera devices, wherein:
the main unit is provided with a system board, the system board is configured with an image analysis unit, an early-warning message unit, a speed signal unit and a video recording unit, and a plurality of electrical members respectively extend from the system board, the electrical members connect to each of the camera devices.

2. The automobile anti-collision early-warning device according to claim 1, wherein the system board is further configured with a sound signal unit, a program modification unit and an emergency signal unit.

3. The automobile anti-collision early-warning device according to claim 1, wherein either a memory card or mobile hard drive is further inserted into the main unit.
